(19) United States
(12) Patent Application Publication
(10) Pub. No.: US 2014/0204294 A1
(43) Pub. Date: Jul. 24, 2014

(54) SUN CONTROL WINDOW FILM WITH LIGHT CONTROL FUNCTION

(71) Applicant: Hongyang Lv, Shanghai (CN)

(72) Inventor: Hongyang Lv, Shanghai (CN)

(73) Assignee: 3M INNOVATIVE PROPERTIES COMPANY, SAINT PAUL, MN (US)

(21) Appl. No.: 14/238,033

(22) PCT Filed: Aug. 23, 2012
(86) PCT No.: PCT/US2012/052010

§ 371 Date: Feb. 10, 2014

(30) Foreign Application Priority Data
Sep. 7, 2011 (CN) 201120334233.7

(51) Int. Cl. G02F 1/1334; G02F 1/13

(52) U.S. Cl. CPC G02F 1/1334; G02F 1/1313
USPC 349/16

(57) ABSTRACT

The present utility model relates to a sun control window film with light control function, comprising: an anti-dirty layer; a curing layer arranged under the anti-dirty layer; a sun control function layer arranged under the curing layer; a first ITO PET layer, wherein a top surface of the first ITO PET layer is attached to the sun control function layer by laminate adhesive; a polymer dispersed liquid crystal layer, wherein a bottom surface of the first ITO PET layer is attached to the polymer dispersed liquid crystal layer by laminate adhesive; a second ITO PET layer, wherein a top surface of the second ITO PET layer is attached to the polymer dispersed liquid crystal layer by laminate adhesive; and a lower surface polyester protective release layer, wherein a bottom surface of the second ITO PET layer is attached to the lower surface polyester protective release layer by contact adhesive.

### FIELD OF THE UTILITY MODEL

The present utility model relates to glass decoration and energy conservation for automobiles and buildings, and more particularly, relates to a solar control film with light control function, which can be adhered to inner surface of glasses in automobiles or buildings. With the solar control film, visible light transmittance can be adjusted in a range from opaque to clear as desired while solar radiant heat is shielded.

### BACKGROUND ART

Now, with the growing consciousness of energy conservation and environment protection and with continuous improvement of people's living standards, application of solar control films becomes more and more popular. The films are commonly adhered to the inner surface of window glasses in automobiles and buildings to shield solar radiant heat from entering, to provide a comfortable and suitable environment for the people inside, and to provide a corresponding degree of privacy according to products with different light transmittance in order to meet desires of the people inside for protecting their privacy.

Solar control film is a functionally treated thin film, having a function of blocking solar radiant heat.

Polymer dispersed liquid crystal (PDLC) film is a photo-electrically responsive material with liquid crystal droplets uniformly dispersed in a polymer matrix. Transparency of the PDLC film may be changed from opaque to clear under an external electric field.

US Patent No. 20080316381 discloses a light control film, which comprises a stain-resistant layer, two polymer film layers, a liquid crystal light control layer, and an adhesive. The light control film has light control and stain-resistant functions.

US Patent No. 20080317977 discloses a light control film, which comprises a stain-resistant layer, an abrasion resistant layer, an anti-glare layer, two polymer film layers, a liquid crystal light control layer, and an adhesive. The light control film has functions of light control, abrasion resistance, anti-reflection, and stain-resistance.

U.S. Pat. No. 005,641,426 discloses an optically responsive film, which comprises liquid crystal droplets dispersed in a cross-linked polymer, wherein the polymer comprises at least one type of vinyl ether.

Major problems with conventional solar control films include:

Visible light transmittance of single-layer solar control film products is fixed and unchangeable, and cannot be adjusted according to people's desire for brightness and darkness as well as for light shielding.

The conventional solar control film products cannot provide a perfect effect on privacy. The effect on privacy provided by the conventional solar control film products would vary depending on observation distance. An observer cannot see the inside of a room clearly through the solar control film from a long distance, but can still see the inside of the room clearly from a short distance.

### DESCRIPTION OF THE UTILITY MODEL

Objective of the present utility model is to provide a solar control film with light control function, and the film's light transmittance can be changed from opaque to clear according to user's desire. In the opaque status, the film completely blocks sight, achieving effects of completely blocking views from outside to protect privacy.

One aspect of the present utility model is to provide a solar control film with light control function, comprising: a scratch and abrasion resistant layer, a bottom coat layer, wherein the bottom coat layer is placed under the scratch and abrasion resistant layer; a heat shield layer, wherein the heat shield layer is placed under the bottom coat layer; a first electrically conductive ITO-coated transparent polyester film, wherein the upper surface of the first electrically conductive ITO-coated transparent polyester film is bound to the heat shield layer by a laminating adhesive; a polymer dispersed liquid crystal layer, wherein the polymer dispersed liquid crystal layer is bound to the lower surface of the first electrically conductive ITO-coated transparent polyester film by a laminating adhesive; a second electrically conductive ITO-coated transparent polyester film, wherein the second electrically conductive ITO-coated transparent polyester film is bound to the upper surface of the polymer dispersed liquid crystal layer by a laminating adhesive; a low surface energy polyester protective release film, wherein the low surface energy polyester protective release film is bound to the lower surface of the second electrically conductive ITO-coated transparent polyester film by a pressure-sensitive adhesive.

Preferably, the heat shield layer is a multi-layer optical film.

Preferably, the heat shield layer is a metal-coated polyester film.

Preferably, the heat shield layer is a dyed polyester film.

Preferably, the metal-coated polyester film is an optical grade polyester film.

Preferably, the dyed polyester film is an optical grade polyester film.

Preferably, the polymer dispersed liquid crystal layer is formed from a mixed solution of polymer monomer, initiator, and nematic liquid crystal droplets through a UV curing process.

Preferably, the first electrically conductive ITO-coated transparent polyester film and the second electrically conductive ITO-coated transparent polyester film are made by a vacuum magnetron sputtering process.

### DESCRIPTION OF THE DRAWINGS

From the following description of embodiments in conjunction with the accompanying drawings, these and/or other aspects and advantages of the illustrative embodiments of the present utility model will become apparent and easier to understand.

FIG. 1 is a cross-sectional sketch of the solar control film with light control function in one embodiment of the present utility model.

### PARTICULAR EMBODIMENTS

The following is a description of particular embodiments of the present utility model based on particular examples. Those skilled in the art will be able to easily understand structure, advantages and functions of the present utility model from what are disclosed in the following embodiments.

The following is a further description of the present utility model in conjunction with the drawings and particular embodiments.

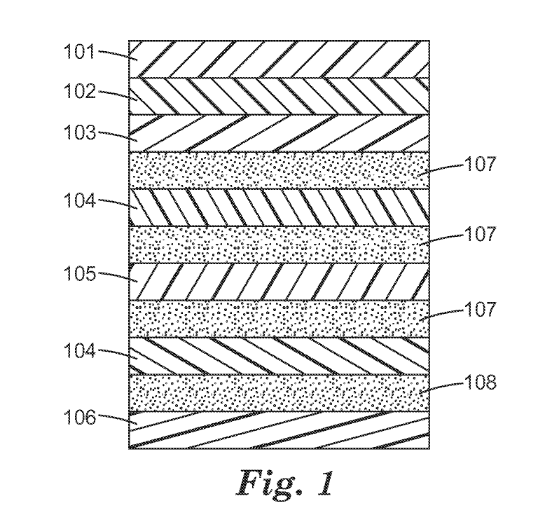

FIG. 1 is a cross-sectional sketch of the solar control film with light control function in one embodiment of the present utility model. As shown in FIG. 1, the solar control film with light control function 100 according to the present utility model comprises: a scratch and abrasion resistant layer 101, a bottom coat layer 102, wherein the bottom coat layer 102 is placed under the scratch and abrasion resistant layer 101; a heat shield layer 103, wherein the heat shield layer 103 is placed under the bottom coat layer 102; a first electrically conductive ITO-coated transparent polyester film 104, wherein the upper surface of the first electrically conductive ITO-coated transparent polyester film 104 is bound to the heat shield layer 103 by the laminating adhesive 107; a polymer dispersed liquid crystal layer 105, wherein the polymer dispersed liquid crystal layer 105 is bound to the lower surface of the first electrically conductive ITO-coated transparent polyester film 104 by the laminating adhesive 107; a second electrically conductive ITO-coated transparent polyester film 104, wherein the upper surface of the second electrically conductive ITO-coated transparent polyester film 104 is bound to the polymer dispersed liquid crystal layer 105 by the laminating adhesive 107; and a low surface energy polyester protective release film 106, wherein the low surface energy polyester protective release film 106 is bound to the lower surface of the second electrically conductive ITO-coated transparent polyester film 104 by the pressure-sensitive adhesive 108.

In the above embodiment, the scratch and abrasion resistant coating materials may be selected from the following materials: carbamate resins, melamine resins, alkyd resins, epoxy resins, acrylic resins, polyester resins, polyvinyl alcohol resins such as polyvinyl alcohol or a copolymer of ethylene and vinyl alcohol, vinyl chloride resins, vinylidene chloride resins, amide resins, imide resins, poly(ether sulfone) resins, polyetherimide resins, vinyl pyrrolidone resins, cellulose resins, acrylonitrile resins and the like, preferably carbamate resins, most preferably urethane acrylate.

The first electrically conductive ITO-coated transparent polyester film 104 and the second electrically conductive ITO-coated transparent polyester film 104 can be made by a vacuum magnetron sputtering process.

According to the embodiment of the present utility model, the polymer dispersed liquid crystal layer 105 is preferably formed from a mixed solution of polymer monomer, initiator, and nematic liquid crystal droplets through a UV curing process. The polymer monomer therein may be an acrylic monomer having a single functional group or multiple functional groups, or a mixture thereof. The mono-functional monomer may be selected from methyl methacrylate, ethyl methacrylate, hydroxyethyl methacrylate, propyl methacrylate, and hydroxypropyl methacrylate. The multiple-functional monomer may be selected from 1,6-hexylene glycol diacrylate (HDDA), dipropylene glycol diacrylate (DPGDA), neopentyl glycol diacrylate (NPGDA), tetraethylene glycol diacrylate (TEGDA), bisphenol-A diacrylate (DDA), tripropylene glycol diacrylate (TPGDA), and trimethylolpropane triacrylate (TMPTA). The initiator may be selected from 1-hydroxycyclohexylphenyl ketone, benzoin ethyl ether, benzoin butyl ether, tribromomethylphenylsulfone, and diphenyl ketone. The nematic liquid crystal may be a liquid crystal monomer selected from acetylenes, biphenyls, phenylcyclohexanes, dicyclohexanes, phnolic esters, or a mixture thereof.

The laminating adhesive 107 and the pressure-sensitive adhesive 108 are a transparent polymer with stickiness, preferably, acrylic or polyester adhesives. In the embodiment according to the present utility model, thickness of the adhesive coating is preferably 5-20 μm. The coating can be applied by, for example, a spray coating machine, a roller coating machine and etc., and can be dried in an oven.

In a preferred embodiment according to the present utility model, the heat shield layer 103 is a multi-layer optical film, and the multi-layer optical film comprises multiple the following layers: a first non-adhesive optical layer with a refraction index n₁, an i^{th} non-adhesive optical layer with a refraction index nᵢ that is higher than n₁, and a multi-layer optical adherend between the first layer and the i^{th} layer, wherein the refraction index of the multi-layer optical adherend layer is between n₁ and nᵢ in an increasing order starting from the first layer.

In another preferred embodiment according to the present utility model, the heat shield layer 103 is a metal-coated polyester film. More preferably, an optical grade polyester film coated with nickel, chromium, gold, silver, titanium, aluminum, copper and the like can be selected, which can be made by vacuum evaporation deposition, vacuum magnetron sputtering and other processes.

In yet another preferred embodiment according to the present utility model, the heat shield layer 103 is a dyed polyester film, more preferably, it is an optical grade dyed polyester film, which can be made by mass coloration, dip-dyeing and other processes.

Compared with the conventional solar control films, the preferred embodiments according to the present utility model have at least one of the following beneficial effects. They have visible light transmittance adjustment function, and their transparency may be changed from opaque to clear under an external electrical field to achieve an effect of being completely transparent or completely covering privacy while shielding heat. They can be adhered to an existing flat or curved glass surface after a simple cutting process so that the glass will have corresponding light control function.

The following data are obtained in experiments when implementing the present utility model:

Based on the experiments, ordinary light control film has visible light transmittance of 74.4%, total solar energy blocking rate of 38.9%, close to the heat shield performance of the ordinary glass. When the heat shield layer is a multi-layer optical film, the solar control film with light control function according to the present utility model has visible light transmittance of 67.7%, 6.7% lower than the ordinary light control film, and human eyes will not perceive the difference and have a bright vision. Total solar energy blocking rate is 47%, 8.1% higher than the ordinary light control film and the heat shield effect is apparent. When the heat shield layer is a metal-coated polyester film, the visible light transmittance is 21.6% lower than the ordinary light control film, and human eyes will feel slightly dim and dark, and the total solar energy blocking rate is 11.5% higher and the heat shield effect is very apparent. When the heat shield layer is a dyed polyester film, the visible light transmittance is 21.9% lower than the ordinary light control film, and human eyes will feel slightly dim and dark, and the total solar energy blocking rate is 5.1% higher, and the heat shield effect is apparent.

The process for preparing the solar control film with light control function of the preferred embodiment according to the present utility model has the following steps:

The first step: coating the laminating adhesive 107 on the first and the second electrically conductive ITO-coated transparent polyester films 104, and laminating the polymer dispersed liquid crystal film 105 between the two electrically conductive films.

The second step: carrying out surface treatment to the heat shield film 103, coating the scratch and abrasion resistant layer 101 and the bottom coat layer 102 with a roller coating machine, and carrying out UV curing.

The third step: coating the laminating adhesive 107 on the other side of the treated heat shield film 103, and laminating the already laminated first and the second electrically conductive films 104 and the polymer dispersed liquid crystal film 105 onto that side.

The fourth step: coating the pressure-sensitive adhesive 108 on the laminated film with a roller coating machine, and laminating the pressure-sensitive adhesive layer with the low surface energy polyester release film 106 on a laminating machine.

The fifth step: cutting the solar control film with light control function into a desired shape and size, and making an electrode.

Although the present utility model has been described in conjunction with the accompanying drawings, the examples disclosed in the drawings are intended to provide an illustration of the preferred embodiments of the present utility model, and should not be construed as a limit to the scope of the present utility model.

Although general contemplation of some embodiments of the present utility model has been shown and explained, those with ordinary skills in the art will understand that changes and modifications can be made to these embodiments without departing from the contemplation principles and spirit of the present utility model. The scope of the present utility model is defined by the appended claims and their equivalents.

1. A sun control window film with light control function, comprising:
an anti-dirty layer;
a curing layer arranged under the anti-dirty layer;
a sun control function layer arranged under the curing layer;
a first ITO PET layer, wherein a top surface of the first ITO PET layer is attached to the sun control function layer by laminate adhesive;
a polymer dispersed liquid crystal layer, wherein a bottom surface of the first ITO PET layer is attached to the polymer dispersed liquid crystal layer by laminate adhesive;
a second ITO PET layer, wherein a top surface of the second ITO PET layer is attached to the polymer dispersed liquid crystal layer by laminate adhesive; and
a lower surface polyester protective release layer, wherein a bottom surface of the second ITO PET layer is attached to the lower surface polyester protective release layer by contact adhesive.

2. The film as claimed in claim 1, wherein the sun control function layer is a multilayer optical film.

3. The film as claimed in claim 1, wherein the sun control function layer is a metal-coating polyester film.

4. The film as claimed in claim 1, wherein the sun control function layer is a dyed polyester film.

5. The film as claimed in claim 3, wherein the metal-coating polyester film is made of polyester film in optical level.

6. The film as claimed in claim 4, wherein the dyed polyester film is made of polyester film in optical level.

7. The film as claimed in claim 1, wherein the polymer dispersed liquid crystal layer is made by mixing a polymer monomers, an initiator and nematic liquid crystal through UV curing process.

8. The film as claimed in claim 1, wherein the first ITO PET layer and the second ITO PET layer are made by sputtering process.
